(19) United States
(12) Patent Application Publication
(10) Pub. No.: US 2026/0171039 A1
(43) Pub. Date: Jun. 18, 2026

(54) DRIVING METHOD AND DRIVING DEVICE FOR IMAGE TO BE DISPLAYED, AND DISPLAY DEVICE

(71) Applicant: TCL CHINA STAR OPTOELECTRONICS TECHNOLOGY CO., LTD., Shenzhen (CN)

(72) Inventors: Haihuan ZHU, Shenzhen (CN); Wennuo HUANG, Shenzhen (CN); Kaihao MAO, Shenzhen (CN); Ming YANG, Shenzhen (CN); Baixin YANG, Shenzhen (CN); Shunqiang YOU, Shenzhen (CN); Shuming CHANG, Shenzhen (CN); Keming CHEN, Shenzhen (CN)

(73) Assignee: TCL CHINA STAR OPTOELECTRONICS TECHNOLOGY CO., LTD., Shenzhen (CN)

(21) Appl. No.: 19/220,062

(22) Filed: May 27, 2025

(30) Foreign Application Priority Data
Dec. 13, 2024 (CN) 202411844929.2

(51) Int. Cl. G09G 3/36

(52) U.S. Cl. CPC G09G 3/3607; G09G 3/3614; G09G 3/3688; G09G 2320/0209

(57) ABSTRACT

A driving method for the image to be displayed includes: obtaining driving voltages for a plurality of sub-pixels corresponding to the image to be displayed; determining a driving load of each of source driver chips when driving each row of the plurality of sub-pixels according to the driving voltages for the plurality of sub-pixels; and determining a driving grayscale value for each one in an i-th row of the plurality of sub-pixels driven by an s-th one of the source driver chips according to the driving load of the s-th one of the source driver chips when driving the i-th row of the plurality of sub-pixels, where s and i are positive integers.

### CROSS-REFERENCE TO RELATED APPLICATION

This application claims priority to Chinese Patent Application No. 202411844929.2, filed on Dec. 13, 2024, the disclosures of which is incorporated herein by reference in its entirety.

### TECHNICAL FIELD

The present application relates to the field of display technologies, and in particular to a driving method and a driving device for an image to be displayed, and a display device.

### BACKGROUND

With the improvement of display panel specifications, when significant grayscale jump changes occur in images to be displayed, factors such as the instability of the VDD driver may cause fluctuations in the driving voltage at both ends of the liquid crystals. As a result, as shown in FIG. 1, single or multiple abnormal dark lines are shown during displaying the image, which affects the display performance of the display device.

### SUMMARY

Embodiments of the present application provide a driving method for an image to be displayed, a driving device for the image to be displayed, and a display device, each of which enables real-time quantification of the degree of dark lines caused by insufficient driving. Moreover, targeted grayscale compensation may be achieved on each sub-pixel, so as to eliminate horizontal crosstalk caused by insufficient driving in real-time, avoid the appearance of single or multiple abnormal dark lines corresponding to the image to be displayed, and enhance the display performance of the display device.

The driving method for the image to be displayed in the embodiments of the present application includes:
obtaining driving voltages for a plurality of sub-pixels corresponding to the image to be displayed;
determining a driving load of each of source driver chips when driving each row of the plurality of sub-pixels according to the driving voltages for the plurality of sub-pixels; and
determining a driving grayscale value for each one in an i-th row of the plurality of sub-pixels driven by an s-th one of the source driver chips according to the driving load of the s-th one of the source driver chips when driving the i-th row of the plurality of sub-pixels, where s and i are positive integers.

Accordingly, embodiments of the present application provide a driving device for the image to be displayed, including:
a voltage acquisition module for obtaining driving voltages for a plurality of sub-pixels corresponding to the image to be displayed;
a load determination module for determining a driving load of each of source driver chips when driving each row of the plurality of sub-pixels according to the driving voltages for the plurality of sub-pixels; and
a grayscale determination module for determining a driving grayscale value for each one in an i-th row of the plurality of sub-pixels driven by an s-th one of the source driver chips according to the driving load of the s-th one of the source driver chips when driving the i-th row of the plurality of sub-pixels, where s and i are positive integers.

Accordingly, embodiments of the present application provide a display device including: a display panel, and the aforementioned driving device for the image to be displayed.

The embodiments of the present application include at least the following beneficial effects.

For the driving method for the image to be displayed provided in the embodiments of the present application, the driving loads of the source driver chips when driving the sub-pixels in each row are determined according to the driving voltages for the plurality of sub-pixels corresponding to the image to be displayed, and the driving grayscale values for the sub-pixels in each row driven by the source driver chips are determined according to the driving loads, and thus the sub-pixels are driven according to the driving grayscale values to achieve image display. Since the driving loads are determined according to the driving voltages for the sub-pixels, and the driving loads reflect the fluctuation of the driving voltages, the degree of dark lines caused by insufficient driving can be real-time quantified. In addition, the driving grayscale values for the sub-pixels are calculated according to the driving loads, which can achieve the targeted grayscale compensation for each sub-pixel, thereby eliminating horizontal crosstalk caused by insufficient driving in real-time, preventing the appearance of one or more abnormal dark lines in the image to be displayed, and enhancing the display performance of the display device.

### BRIEF DESCRIPTION OF THE DRAWINGS

FIG. 1 is a schematic diagram of dark lines shown in an image display process;

FIG. 2 is a schematic diagram of a driving method for an image to be displayed provided in embodiments of the present application;

FIG. 3 is a schematic diagram of a voltage mapping table provided in embodiments of the present application;

FIG. 4 is a schematic diagram illustrating a sequence of pixels to be driven provided in embodiments of the present application;

FIG. 5 is a schematic diagram of weight coefficients provided in embodiments of the present application;

FIG. 6 is a schematic diagram of a coefficient mapping table provided in embodiments of the present application;

FIG. 7 is a schematic diagram of a grayscale mapping table provided in embodiments of the present application; and

FIG. 8 is a block diagram of a driving device for an image to be displayed provided in embodiments of the present application.

### DETAILED DESCRIPTION

Technical proposals of the present application will be described below in conjunction with the accompanying drawings. The technical proposals described are for the purpose of explaining and illustrating the concepts of the present application and should not be construed as limitations on the scope of protection of the present application.

In addition, the term “a plurality of” in the present application refers to two or more. The terms “first” and “second” in the present application are used to distinguish different technical features and do not imply any order, quantity, or significance.

The embodiments provided in the present application are similar, and features in different embodiments can be combined with each other.

The order of the following descriptions of the embodiments does not imply a preference for the order of the embodiments.

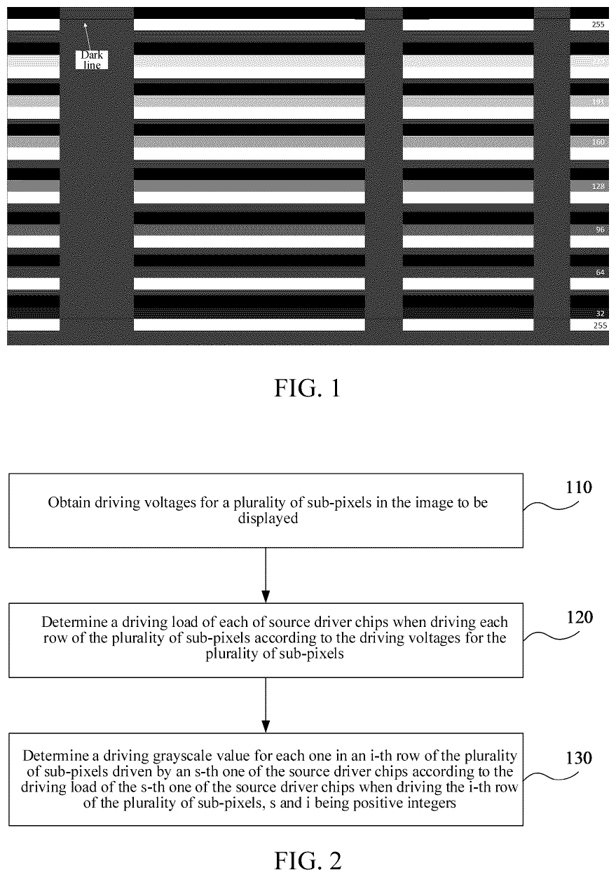

Referring to FIG. 2 which is a flowchart of a driving method for an image to be displayed provided in embodiments of the present application, the driving method for the image to be displayed may include following steps.

In step 110, driving voltages for a plurality of sub-pixels corresponding to the image to be displayed are obtained.

In step 120, driving loads of source driver chips when driving sub-pixels in each row are determined according to the driving voltages for the plurality of sub-pixels.

In step 130, driving grayscale values for sub-pixels in an i-th row driven by an s-th one of the source driver chips are determined according to a driving load of the s-th source driver chip when driving the sub-pixels in the i-th row, where s is a positive integer, and i is a positive integer.

In the embodiments of the present application, after the image to be displayed is obtained, data processing such as format conversion or data mapping may be performed on the image to obtain the pixel architecture distribution. The pixel architecture distribution refers to the spatial arrangement of the plurality of sub-pixels corresponding to the image to be displayed according to the driving architecture for the display device. One pixel corresponding to the image to be displayed may generally correspond to three sub-pixels, which are red (R) sub-pixel, green (G) sub-pixel, and blue (B) sub-pixel, respectively, and the embodiments of the present application are not limited to this. For example, in practical applications, one pixel may also correspond to four sub-pixels, which are R sub-pixel, G sub-pixel, B sub-pixel, and white (W) sub-pixel, respectively. In addition, the driving architecture for the display device in the present application includes, but is not limited to, a FLIP architecture (also referred to as 1G1D FLIP architecture, which means that one gate line and one data line are in an inversion arrangement), a Stripe architecture (also referred to as 1G1D Stripe architecture, which means that one gate line and one data line are in a stripe arrangement), a DLS (Data Line Sharing) architecture, and other architectures. The DLS architecture achieves the purpose of reducing the data lines by half by allowing horizontally adjacent sub-pixels to share a single data line while being addressed by different scan lines. Meanwhile, the charging time of the pixels is halved due to the doubling of the scan lines. In the embodiments of the present application, the input image to be displayed is converted into an actual pixel architecture distribution and the loads are calculated based on the actual pixel architecture distribution.

After data processing of the image to be displayed, the driving voltage for each sub-pixel corresponding to the image to be displayed may be obtained. Optionally, the driving voltage for each sub-pixel can be directly obtained, or quantified according to other parameters of the sub-pixel, which is not limited in the embodiments of the present application. For example, the grayscale value for each sub-pixel corresponding to the image to be displayed can be firstly obtained, and then the grayscale value for each sub-pixel is converted into the driving voltage for the sub-pixel.

Considering an example in which the driving voltage for each sub-pixel is quantified according to the grayscale value for each sub-pixel, step 110 includes the following steps.

In step 101, initial grayscale values for the plurality of sub-pixels corresponding to the image to be displayed are obtained.

In step 102, a driving manner for the image to be displayed is determined.

In step 103, if the driving manner is a positive polarity driving manner, the driving voltages for the plurality of sub-pixels are determined according to the initial grayscale values for the plurality of sub-pixels and a preset first voltage mapping table.

In step 104, if the driving manner is a negative polarity driving manner, the driving voltages for the plurality of sub-pixels are determined according to the initial grayscale values for the plurality of sub-pixels and a preset second voltage mapping table.

The positive polarity driving manner drives the pixels with a positive polarity voltage, which refers to a driving voltage with a value greater than the common voltage. The positive polarity driving manner enables liquid crystal molecules to align in a specific direction, thereby controlling the passage of light to form an image for display purposes. The negative polarity driving manner drives the pixels with a negative polarity voltage, which refers to a driving voltage with a value less than the common voltage. The alignment direction of the liquid crystal molecules in the negative polarity driving manner is opposite to that in the positive polarity driving manner, and the negative polarity driving manner may also control the passage of light to form the image for the display purposes. In practical applications, an alternating polarity driving manner (i.e., alternating between the positive polarity driving manner and the negative polarity driving manner) is generally adopted to reduce the polarization and residual image phenomena of the liquid crystal molecules caused by the long-term application of a voltage with the same polarity. This manner can effectively reduce the polarization of the liquid crystal molecules, extend the service life of the display device, and improve the display quality.

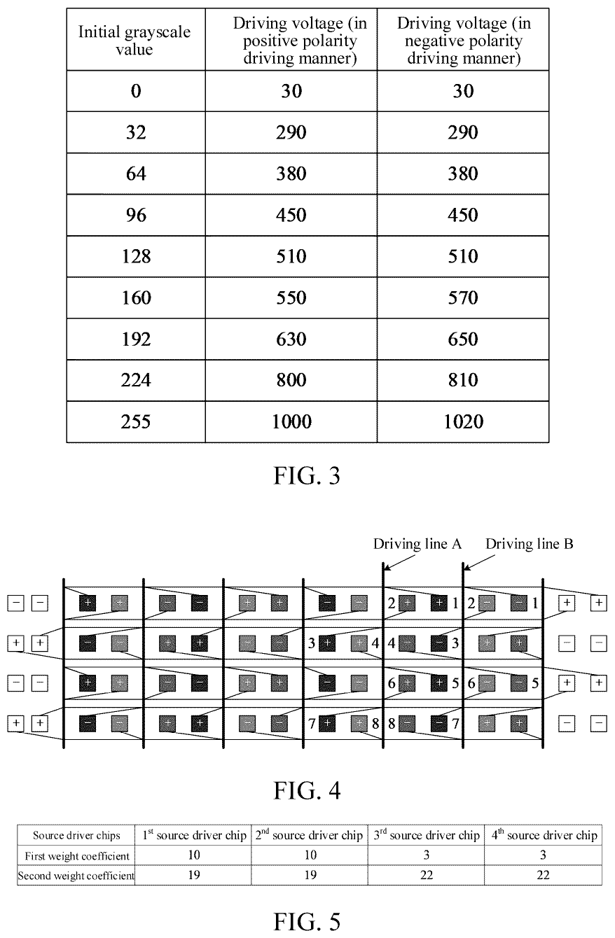

It is precisely because there are slight differences in the speed of response and voltage drop between the positive polarity driving manner and the negative polarity driving manner that two voltage mapping tables corresponding to the two driving manners are established in advance in the embodiments of the present application. That is, the first voltage mapping table and the second voltage mapping table are established. The first voltage mapping table includes the mapping relationship between the initial grayscale values and the driving voltages in the positive polarity driving manner, and the second voltage mapping table includes the mapping relationship between the initial grayscale values and the driving voltages in the negative polarity driving manner. When the driving voltages for the plurality of sub-pixels corresponding to the image to be displayed are obtained, the positive polarity driving manner or the negative polarity driving manner for the image to be displayed is firstly determined; then the corresponding voltage mapping table is obtained according to the positive polarity driving manner or the negative polarity driving manner; and next, the driving voltages corresponding to the initial grayscale values for the sub-pixels are further determined from the obtained voltage mapping table. Optionally, the first voltage mapping table and the second voltage mapping table may be two mapping tables independent of each other or two mapping sub-tables located in a same mapping table. For example, as shown in FIG. 3, in the embodiments of the present application, a mapping table is established in advance, and the mapping table includes three columns, where the first column is for the initial grayscale values, the second column is for the driving voltages corresponding to the initial grayscale values in the positive polarity driving manner, and the third column is for the driving voltages corresponding to the initial grayscale values in the negative polarity driving manner. Thus, the mapping sub-table formed by the first column and the second column is the first voltage mapping table, and the mapping sub-table formed by the first column and the third column is the second voltage mapping table.

The display device may provide driving voltages for the plurality of sub-pixels through a source integrated circuit (Source IC), which may also be referred to as the source driver chip, or Driver IC, etc. The number of data channels of the source driver chip refers to the number of channels of the source driver chip used for transmitting data signals, with each channel capable of providing data for a certain number of sub-pixels. Since the number of channels of a single source driver chip is limited, the display device is generally driven by a plurality of source driver chips. For example, the number of the source driver chips ranges from 4 to 24.

In the embodiments of the present application, the display device is driven by the plurality of source driver chips, one of the source driver chips may include one or more driving lines. Sub-pixels in a row corresponding to the image to be displayed are driven by the source driver chips, and the sub-pixels driven by one of the source driver chips may be distributed in multiple rows corresponding to the image to be displayed. One source driver chip may drive sub-pixels in multiple rows in a time-division manner, where the time-division driving refers to driving sub-pixels in one row at a time before proceeding to sub-pixels in the next row. Therefore, to capture the fluctuations in driving voltages more accurately, in the embodiments of the present application, the driving loads of the source driver chips when driving the sub-pixels in each row are determined according to the driving voltages for the plurality of sub-pixels corresponding to the image to be displayed. The driving loads of the source driver chips when driving the sub-pixels in a single row indicates the voltage fluctuation of the sub-pixels in the single row driven by the source driver chip. It should be understood that sub-pixels driven by different source driver chips in the same row are different from each other. In other words, a sub-pixel is driven by one source driver chip, and there is no intersection between the sub-pixels driven by different source driver chips. The calculation process of the driving loads refers to the following embodiments, which will not be described here.

Based on the driving loads of the source driver chips when driving the sub-pixels in each row, the degree of the dark line in the area driven by the source driver chips in each row can be clearly identified. The greater the driving loads, the deeper the degree of the dark line. In the embodiments of the present application, the driving grayscale values for the sub-pixels driven by the source driver chips in each row are determined according to the driving loads of the source driver chips when driving the sub-pixels in each row, thereby driving the sub-pixels according to the driving grayscale values to achieve image display. For example, the driving grayscale values for the sub-pixels in the i-th row driven by the s-th source driver chip may be determined according to the driving load of the s-th source driver chip when driving the sub-pixels in the i-th row. Since targeted grayscale compensation is performed for each of the sub-pixels according to the driving loads in the driving process of the sub-pixels in the embodiments of the present application, the horizontal crosstalk caused by insufficient driving can be eliminated. That is, one or more dark lines are eliminated. The calculation process of the driving grayscale values for the sub-pixels can be referred to the following embodiments, and will not be described here.

In summary, the driving loads of the source driver chips when driving the sub-pixels in each row are determined according to the driving voltages for the plurality of sub-pixels corresponding to the image to be displayed, and the driving grayscale values for the sub-pixels in each row driven by the source driver chips are determined according to the driving loads, and thus the sub-pixels are driven according to the driving grayscale values to achieve image display. Since the driving loads are determined according to the driving voltages for the sub-pixels, and the driving loads reflect the fluctuation of the driving voltages, the degree of dark lines caused by insufficient driving can be real-time quantified. In addition, the driving grayscale values for the sub-pixels are calculated according to the driving loads, which can achieve the targeted grayscale compensation for each sub-pixel, thereby eliminating horizontal crosstalk caused by insufficient driving in real-time, preventing the appearance of one or more abnormal dark lines in the image to be displayed, and enhancing the display performance of the display device.

The calculation process of driving loads will be described below.

In an example, step 120 includes the following steps.

In step 121, initial loads of the source driver chips when driving the sub-pixels in each row are determined according to the driving voltages for the plurality of sub-pixels.

In step 122, a total load for the sub-pixels in the i-th row is determined according to the initial loads of the source driver chips when driving the sub-pixels in the i-th row.

In step 123, the driving load of the s-th source driver chip when driving the sub-pixels in the i-th row is determined according to an initial load of the s-th source driver chip when driving the sub-pixels in the i-th row and the total load for the sub-pixels in the i-th row.

The source driver chips generally share one power supply voltage, such as AVDD. For the sake of description, the power supply voltage shared by the source driver chips is referred to as the power supply voltage for the display device in the embodiments of the present application. In actual applications, the power supply voltage may also be referred to as the PMIC power supply voltage, which is not limited in the embodiments of the present application. When the load suddenly increases, there will be insufficient driving, and the power supply voltage will be pulled down, and then cases such as the AVDD drop will happen. The drop in the supply voltage also affects the driving capability of the source driver chips. Therefore, in the embodiments of the present application, for the load corresponding to each source driver chip, in addition to the load generated by the source driver chip itself, the load generated by other source driver chips is taken into account. For the sake of description, in embodiments of the present application, the load generated by each source driver chip itself is referred to as the initial load, and after integrating the influence of the load generated by other source driver chips, the final load corresponding to the source driver chip is referred to as the driving load.

In the embodiments of the present application, in order to integrate the influence of the load generated by other source driver chips on the source driver chip, the total load is calculated according to the initial loads corresponding to the source driver chips after the initial load corresponding to each of the source driver chips is calculated, and then the driving load corresponding to each source driver chip is calculated according to the total load and the initial load corresponding to the source driver chip.

In an example, step 121 includes the following steps.

In step 1211, pixel loads for the sub-pixels in the i-th row driven by the s-th source driver chip are determined according to the driving voltages for the plurality of sub-pixels.

In step 1212, the initial load of the s-th source driver chip when driving the sub-pixels in the i-th row is determined according to the pixel loads for the sub-pixels in the i-th row driven by the s-th source driver chip.

The loads are used to indicate the fluctuation of the driving voltages. Therefore, in the embodiments of the present application, the pixel loads for the sub-pixels are firstly calculated according to the driving voltages for the plurality of sub-pixels, and then the initial loads of the source driver chip are calculated according to the pixel loads for the sub-pixels.

The pixel load for the current sub-pixel is determined according to the driving voltage for the current sub-pixel and the driving voltage for the preceding sub-pixel. The preceding sub-pixel is adjacent to the current sub-pixel in the pixel driving sequence and refers to the sub-pixel that is driven immediately before the current sub-pixel in the sequence. The pixel driving sequence refers to the order in which the sub-pixels are driven by the source driver chip. The pixel driving sequence may be directly obtained by the display device. For example, the pixel driving sequence is input to the display device together with the image to be displayed. Alternatively, the pixel driving sequence may also be obtained by the display device after obtaining the image to be displayed, and performing processes such as data mapping based on the driving architecture and image to be displayed.

For example, considering the DLS architecture as an example, as shown in FIG. 4, the squares and the vertical lines in FIG. 4 represent sub-pixels and driving lines, respectively. One source driver chip may include one or more driving lines, and one driving line drives sub-pixels in four columns. As shown in FIG. 4, considering the sub-pixels shown in FIG. 4 as an example, the sequence of the sub-pixels driven by the driving line A is: the red sub-pixel 1 in the first row, the blue sub-pixel 2 in the first row, the red sub-pixel 3 in the second row, the green sub-pixel 4 in the second row, the red sub-pixel 5 in the third row, the blue sub-pixel 6 in the third row, the red sub-pixel 7 in the fourth row, and the green sub-pixel 8 in the fourth row. The sequence of the sub-pixels driven by the driving line B in FIG. 4 is: the blue sub-pixel 1 in the first row, the green sub-pixel 2 in the first row, the red sub-pixel 3 in the second row, the blue sub-pixel 4 in the second row, the blue sub-pixel 5 in the third row, the green sub-pixel 6 in the third row, the red sub-pixel 7 in the fourth row, and the blue sub-pixel 8 in the fourth row.

Considering an Sᵢₜ-th sub-pixel in the i-th row driven by the s-th source driver chip as an example, step 1211 includes: for a sᵢₜ-th sub-pixel in the i-th row driven by the s-th source driver chip, determining a preceding sub-pixel driven by the s-th source driver chip before driving the sᵢₜ-th sub-pixel; and determining a pixel load for the Sᵢₜ-th sub-pixel according to a driving voltage for the Sᵢₜ-th sub-pixel and a driving voltage for the preceding sub-pixel.

Determining the pixel load for the sᵢₜ-th sub-pixel according to the driving voltage for the Sᵢₜ-th sub-pixel and the driving voltage for the preceding sub-pixel, includes: if the driving voltage for the Sᵢₜ-th sub-pixel is less than or equal to the driving voltage for the preceding sub-pixel, determining the pixel load for the Sᵢₜ-th sub-pixel as zero; and if the driving voltage for the sᵢₜ-th sub-pixel is greater than the driving voltage for the preceding sub-pixel, subtracting the driving voltage for the preceding sub-pixel from the driving voltage for the Sᵢₜ-th sub-pixel to obtain the pixel load for the sᵢₜ-th sub-pixel.

The initial load of the s-th source driver chip when driving the sub-pixels in the i-th row is the sum of the pixel loads for the sub-pixels in the i-th row driven by the s-th source driver chip. For example, the calculation formula for the initial load of the s-th source driver chip when driving the sub-pixels in the i-th row is as follows:

$$Δ {V}_{si} = {\sum }_{t = 1}^{m} P ( {s}_{it} ) ,$$

where P(Sᵢₜ) refers to the pixel load for the sᵢₜ-th sub-pixel in the i-th row driven by the s-th source driver chip; It refers to the total number of the sub-pixels in the i-th row driven by the s-th source driver chip; t is a positive integer less than or equal to m; and ΔVₛᵢ refers to the initial load of the s-th source driver chip when driving the sub-pixels in the i-th row.

It should be understood that, the calculation of the initial loads of other source driver chips when driving sub-pixels in the i-th row can follow the calculation of the initial load of the s-th source driver chip when driving the sub-pixels in the i-th row, which will not be repeated here.

In an example, step 122 includes the following steps.

In step 1221, first weight coefficients for the source driver chips are obtained. Each of the first weight coefficients is used to indicate a degree of influence of the load of a source driver chip on the power supply voltage for the display device.

In step 1222, a weighted summation is performed on the initial loads of the source driver chips when driving the sub-pixels in the i-th row according to the first weight coefficients for the source driver chips, so as to obtain the total load for the sub-pixels in the i-th row.

The first weight coefficients may be preset in the display device. For example, the first weight coefficients for the source driver chips are obtained in advance by manual debugging, and then the mapping relationship between the first weight coefficients and the source driver chips is preset in the display device, so that the display device can obtain the first weight coefficients for the source driver chips from its own storage.

Since the influence of the load of different source driver chips on the power supply voltage for the display device may be different, in the embodiments of the present application, the total load for the sub-pixels in the i-th row is obtained by performing the weighted summation on the initial loads of the source driver chips when driving the sub-pixels in the i-th row according to the first weight coefficients for the source driver chips. For example, the calculation formula for the total load for the sub-pixels in the i-th row is as follows:

$$Δ {V}_{i} = {A}_{1} Δ {V}_{1 i} + {A}_{2} Δ {V}_{2 i} + ⋯ {A}_{s} Δ {V}_{si} + ⋯ + {A}_{N} Δ {V}_{Ni} ,$$

where ΔVᵢ refers to the total load for the sub-pixels in the i-th row; A₁ refers to the first weight coefficient for the first source driver chip, A₂ refers to the first weight coefficient for the second source driver chip, Aₛ refers to the first weight coefficient for the s-th source driver chip, and A_{N} refers to the first weight coefficient for the N-th source driver chip, where N is the total number of the source driver chips, N is a positive integer, and s is a positive integer less than or equal to N; ΔV₁ᵢ refers to the initial load of the first source driver chip when driving sub-pixels in the i-th row, ΔV₂ᵢ refers to the initial load of the second source driver chip when driving sub-pixels in the i-th row, ΔVₛᵢ refers to the initial load of the s-th source driver chip when driving sub-pixels in the i-th row, and ΔV_{Ni} refers to the initial load of the N-th source driver chip when driving sub-pixels in the i-th row.

In an example, step 123 includes the following steps.

In step 1231, second weight coefficients for the source driver chips are obtained. Each of the second weight coefficients is used to indicate an influence degree of a decrease in a supply voltage for the display device on the load of a source driver chip.

In step 1232, the initial load of the s-th source driver chip when driving the sub-pixels in the i-th row is added to a product of the second weight coefficient for the s-th source driver chip and the total load for the sub-pixels in the i-th row to obtain the driving load of the s-th source driver chip when driving the sub-pixels in the i-th row.

The second weight coefficients may be preset in the display device. For example, the second weight coefficients for the source driver chips are obtained in advance by manual debugging, and then the mapping relationship between the second weight coefficients and the source driver chips is preset in the display device, so that the display device can obtain the second weight coefficients for the source driver chips from its own storage.

The display device calculates the product of the second weight coefficient for each source driver chip and the total load for the sub-pixels in each row, and then adds the product to the initial load of the source driver chip when driving the sub-pixels in the row to obtain the driving load of the source driver chip when driving the sub-pixels in the row. For example, the calculation formula for the driving load of the s-th source driver chip when driving the sub-pixels in the i-th row is as follows:

$$Δ {Q}_{si} = Δ {V}_{si} + {B}_{s} Δ {V}_{si} ,$$

where Bₛ refers to the second weight coefficient for the s-th source driver chip; ΔVᵢ refers to the total load for the sub-pixels in the i-th row; ΔVₛᵢ refers to the initial load of the s-th source driver chip when driving the sub-pixels in the i-th row; and ΔQₛᵢ refers to the driving load of the s-th source driver chip when driving the sub-pixels in the i-th row.

Optionally, since the influence of the loads of different source driver chips on the power supply voltage for the display device and the influence of the decrease in the power supply voltage on the loads of the source driver chips are relatively independent, the relationship between the first weight coefficients and the second weight coefficients for the source driver chips is not limited in the embodiments of the present application. For example, the sum of the first weight coefficients for the source driver chips does not need to meet the condition of being equal to 1. As shown in FIG. 5, considering an example in which the display device includes four source driver chips, FIG. 5 illustrates a possible case in which the first weight coefficients and second weight coefficients are obtained after manual debugging. In actual applications, the weight coefficients shown in FIG. 5 may be divided by a preset value to map to the range of 0 to 1, and then used for the calculation of the loads.

When AVDD drop occurs, a certain amount of time needs to be taken for AVDD to recover to the normal level, and thus the load for sub-pixels in the current row affects the load for sub-pixels in the preceding rows. In an example, after step 120 or step 123, the driving method further includes: correcting the driving load of the s-th source driver chip when driving the sub-pixels in the i-th row according to a driving load of the s-th source driver chip when driving sub-pixels in an (i-1)-th row. The corrected driving load of the s-th source driver chip when driving the sub-pixels in the i-th row is used to determine the driving grayscale values for the sub-pixels in the i-th row driven by the s-th source driver chip.

Optionally, the correcting the driving load of the s-th source driver chip when driving the sub-pixels in the i-th row according to the driving load of the s-th source driver chip when driving the sub-pixels in the (i−1)-th row, includes: performing a weighted summation on the driving load of the s-th source driver chip when driving the sub-pixels in the (i−1)-th row and the driving load of the s-th source driver chip when driving the sub-pixels in the i-th row, so as to obtain the corrected driving load of the s-th source driver chip when driving the sub-pixels in the i-th row. Optionally, when performing the weighted summation to correct the driving load of the s-th source driver chip when driving the sub-pixels in the i-th row, the larger the driving load of the s-th source driver chip when driving the sub-pixels in the (i−1)-th row, the weight corresponding to the driving load of the s-th source driver chip when driving the sub-pixels in the (i−1)-th row is greater. Optionally, the weight based on which the weighted summation is performed may be obtained according to debugging values or empirical values, and is not limited in the embodiments of the present application.

It should be noted that, in addition to the driving load of the s-th source driver chip when driving the sub-pixels in the (i−1)-th row, the driving load, when driving the sub-pixels in the i-th row, of the s-th source driver chip may be corrected according to the driving load of the s-th source driver chip when driving sub-pixels in the (i-2)-th row, etc. That is, the driving load of the source driver chip when driving sub-pixels in a row can affect the driving load of the same source driver chip when driving sub-pixels in preceding one or more rows. Correspondingly, the driving load of a source driver chip when driving sub-pixels in a row may be affected by the driving load of the same source driver chip when driving the sub-pixels in previous one or more rows. Optionally, the influence of the driving load of the source driver chip when driving the sub-pixels in a row on the driving load of the same source driver chip when driving sub-pixels in preceding multiple rows decreases with the increase of the number of rows.

It should be understood that, the calculation of the driving load of other source driver chips when driving the sub-pixels in the i-th row, as well as the calculation of the driving load of each source driver chip when driving the sub-pixels in other rows, can follow the calculation of the driving load of the s-th source driver chip when driving the sub-pixels in the i-th row, which will not be repeated here.

In summary, in the driving method for the image to be displayed provided in the present application, when the driving load of each of the source driver chips is calculated, not only the load generated by the source driver chip itself, but also the influence of the load generated by other source driver chips on the source driver chip is taken into account, making the driving load of the source driver chip more accurate, thereby improving the accuracy of the quantification of the degree of dark lines, and also contributing to the accuracy of grayscale compensation.

The process of calculating the driving grayscale value will be described below.

In an example, step 130 includes the following steps.

In step 131, for the Sᵢₜ-th sub-pixel in the i-th row that is driven by the s-th source driver chip, a grayscale mapping coefficient corresponding to the Sᵢₜ-th sub-pixel is determined according to a preset coefficient mapping table, an initial grayscale value for the Sᵢₜ-th sub-pixel, and the driving load of the s-th source driver chip when driving the sub-pixels in the i-th row. The coefficient mapping table includes grayscale mapping coefficients corresponding to multiple sets of initial grayscale values and driving loads.

In step 132, the driving grayscale value for the sᵢₜ-th sub-pixel is determined according to the grayscale mapping coefficient corresponding to the Sᵢₜ-th sub-pixel, and the driving load of the s-th source driver chip when driving the sub-pixels in the i-th row.

The degree of compensation for one sub-pixel varies under different driving loads. In the embodiments of the present application, the degree of compensation for the sub-pixel can be reflected by the grayscale mapping coefficient. The coefficient mapping table may be preset in the display device, and the grayscale mapping coefficient may be obtained from the coefficient mapping table. Optionally, since the driving capabilities and driving lines of different source driver chips are different, a corresponding coefficient mapping table may be preset for each of the source driver chips. When the grayscale mapping coefficient corresponding to one sub-pixel needs to be obtained, the coefficient mapping table corresponding to a source driver chip driving the sub-pixel may be firstly obtained, and then the grayscale mapping coefficient corresponding to the sub-pixel may be obtained from the coefficient mapping table.

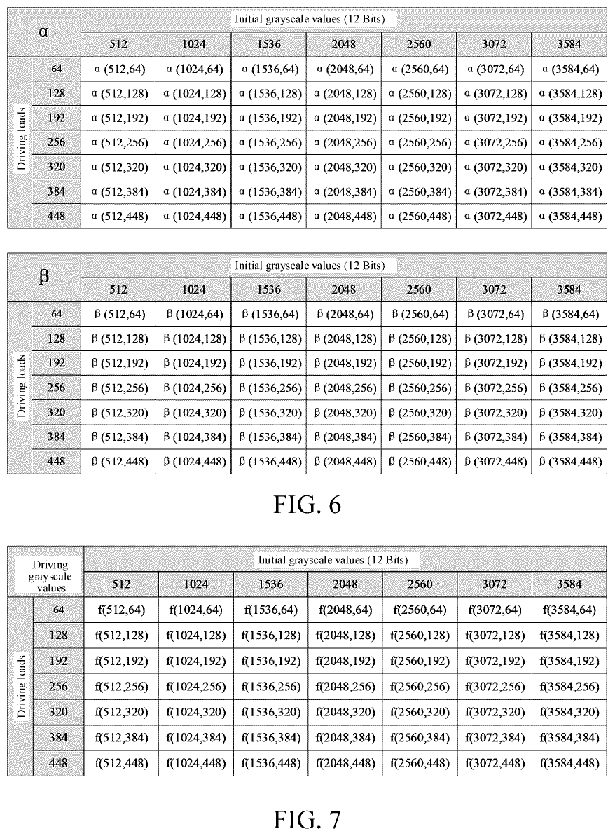

Optionally, the grayscale mapping coefficient may include one or more mapping sub-coefficients, with different mapping sub-coefficients corresponding to different mapping sub-tables. For example, as shown in FIG. 6, considering a coefficient mapping table corresponding to a source driver chip as an example, the grayscale mapping coefficient includes a mapping sub-coefficient α and a mapping sub-coefficient β. The coefficient mapping table includes two mapping sub-tables, in which one mapping sub-table includes the mapping sub-coefficient α corresponding to multiple sets of initial grayscale values and driving loads, and the other mapping sub-table includes mapping sub-coefficients β corresponding to multiple sets of initial grayscale values and driving loads, and the mapping coefficients in the coefficient mapping table may be obtained through manual debugging.

It should be understood that, the coefficient mapping table may not include all mapping coefficients corresponding to all initial grayscale values and driving loads, and if at least one of the initial grayscale value or driving load of a certain sub-pixel is not listed in the coefficient mapping table, the mapping coefficient may be obtained from the coefficient mapping table in a bilinear interpolation manner.

When the driving grayscale value for each of the sub-pixels is calculated, the compensation grayscale value to be compensated for the sub-pixel can be firstly calculated through the grayscale mapping coefficient, and then the compensation grayscale value is added to the initial grayscale value for the sub-pixel to obtain the driving grayscale value for the sub-pixel.

In an example, the step 132 includes the following steps:

In step 1321, the compensation grayscale value for the Sᵢₜ-th sub-pixel is determined according to the grayscale mapping coefficient corresponding to the Sᵢₜ-th sub-pixel, and the driving load of the s-th source driver chip when driving the sub-pixels in the i-th row.

In step 1322, the initial grayscale value and the compensation grayscale value for the sᵢₜ-th sub-pixel are summed to obtain the driving grayscale value for the Sᵢₜ-th sub-pixel.

For example, considering an example in which the grayscale mapping coefficient includes the mapping sub-coefficient α and the mapping sub-coefficient β, the calculation formula for the compensation grayscale value for the sᵢₜ-th sub-pixel is as follows:

$$Δ {Gray}_{{s}_{it}} = αΔ {Q}_{si} + β ,$$

where ΔGrayₛ_{ᵢₜ} refers to the compensation grayscale value for the Sᵢₜ-th sub-pixel; ΔQₛᵢ refers to the driving load of the s-th source driver chip when driving the sub-pixels in the i-th row.

Optionally, before step 1322, the driving method further includes: optimizing the compensation grayscale value for the Sᵢₜ-th sub-pixel by using a voltage difference coefficient, the voltage difference coefficient being determined according to a voltage difference between the power supply voltage for the display device and the driving voltage for the target grayscale value. Optionally, the target grayscale value is the grayscale value of the maximum grayscale. For example, if the grayscale value ranges from 0 to 255, the target grayscale value is 255. When the power supply voltage is close to the driving voltage for the target grayscale value, the degree of dark lines is relatively deep. Therefore, in this example, the compensation grayscale value is optimized by using the voltage difference coefficient, and the driving grayscale value for the sub-pixel is the sum of the original grayscale value for the sub-pixel and the optimized compensation grayscale value.

For example, the calculation formula for the optimized compensation grayscale value for the Sᵢₜ-th sub-pixel is as follows:

$$Δ {Gray}_{{s}_{it}} = γ ( αΔ {Q}_{si} + β ) ,$$

where γ refers to the voltage difference coefficient, and the smaller the voltage difference between the power supply voltage for the display device and the driving voltage for the target grayscale value, the smaller the voltage difference coefficient is.

In an example, step 130 includes the following γ steps.

In step 133, the driving grayscale value for the Sᵢₜ-th sub-pixel in the i-th row driven by the s-th source driver chip is determined according to a preset grayscale mapping table, the initial grayscale value for the sᵢₜ-th sub-pixel, and the driving load of the s-th source driver chip when driving the sub-pixels in the i-th row. The grayscale mapping table includes driving grayscale values corresponding to multiple sets of initial grayscale values and driving loads.

In this example, the grayscale mapping table may also be established, and the driving grayscale value may be obtained from the grayscale mapping table according to the initial grayscale value and driving load without calculating the compensation grayscale value. For example, as shown in FIG. 7, the grayscale mapping table shown in FIG. 7 includes driving grayscale values corresponding to the multiple sets of initial grayscale values and driving loads. It should be understood that the grayscale mapping table may not include all driving grayscale values corresponding to all initial grayscale values and driving loads. If at least one of the initial grayscale value or the driving load of a certain sub-pixel is not listed in the grayscale mapping table, the driving grayscale may be obtained from the grayscale mapping table in the bilinear interpolation manner.

Optionally, one grayscale mapping table may be preset for each of the source driver chips. When the driving grayscale value for a sub-pixel needs to be obtained, the corresponding grayscale mapping table is firstly obtained according to the source driver chip driving the sub-pixel, and then the driving grayscale value is obtained corresponding to the sub-pixel from the grayscale mapping table.

For example, the calculation formula for the driving grayscale value for the Sᵢₜ-th sub-pixel is as follows:

$${Gray}_{{s}_{it}}^{′} = f ( {Gray}_{{s}_{it}} , Δ {Q}_{si} ) ,$$

where Grayₛ_{ᵢₜ} refers to the initial grayscale value for the Sᵢₜ-th sub-pixel, ΔQₛᵢ refers to the driving load of the s-th source driver chip when driving the sub-pixels in the i-th row, and Graysₛ_{ᵢₜ}′ refers to the driving grayscale value for the Sᵢₜ-th sub-pixel. In this example, the grayscale mapping table corresponding to the s-th source driver chip is firstly obtained, and then the driving grayscale value corresponding to the initial grayscale value and driving load is obtained from the grayscale mapping table.

Optionally, after step 133, the driving method further includes: optimizing the driving grayscale value for the Sᵢₜ-th sub-pixel by using a voltage difference coefficient, the voltage difference coefficient being determined according to a voltage difference between a power supply voltage for the display device and a driving voltage for a target grayscale value. Optionally, the target grayscale value is the grayscale value of the maximum grayscale. For example, if the grayscale value ranges from 0 to 255, the target grayscale value is 255. When the power supply voltage is close to the driving voltage for the target grayscale value, the degree of dark lines is relatively deep. Therefore, the driving grayscale value is optimized by using the voltage difference coefficient in this example.

For example, the calculation formula for the optimized driving grayscale value for the Sᵢₜ-th sub-pixel is as follows:

$${Gray}_{{s}_{it}}^{′} = γ \times f ( {Gray}_{{s}_{it}} , Δ {Q}_{si} ) ,$$

where γ refers to the voltage difference coefficient, and the smaller the voltage difference between the power supply voltage for the display device and the driving voltage for the target grayscale value, the smaller the voltage difference coefficient γ is.

It should be understood that, in the embodiments of the present application, for the sake of description, the original uncompensated grayscale value for a sub-pixel is referred to as the initial grayscale value, the grayscale value that needs to be increased or decreased during the compensation process of the sub-pixel is referred to as the compensation grayscale value, and the compensated grayscale value for the sub-pixel is referred to as the driving grayscale value.

In summary, for the driving method for the image to be displayed provided in the embodiments of the present application, the driving grayscale value for each sub-pixel is calculated according to the driving loads, which can achieve targeted grayscale compensation for each sub-pixel, to eliminate horizontal crosstalk caused by insufficient driving in real-time, avoid the appearance of single or multiple abnormal dark lines in the image to be displayed, and enhance the display performance of the display device. Moreover, the embodiments of the present application provide various manners to determine the driving grayscale value, which can be flexibly selected according to the requirements to determine the driving grayscale value.

To better implement the driving method for the image to be displayed provided in the embodiments of the present application, the embodiments of the present application provide a driving device for the image to be displayed, and the driving device includes program code or IP core, which may be used to execute the aforementioned driving method for the image to be displayed. The terms have the same meanings as in the aforementioned driving method for the image to be displayed, and for specific implementation details, reference can be made to the description in the embodiments for the driving method.

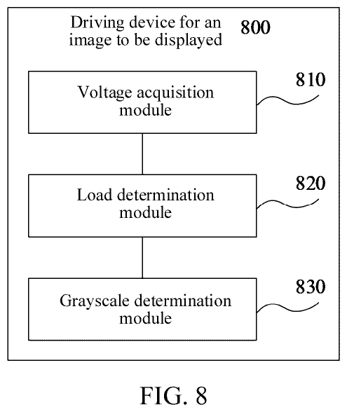

Referring to FIG. 8 as a schematic diagram of the driving device for the image to be displayed provided in the embodiments of the present application. The program code or IP core in the driving device for the image to be displayed may be located in the modules as shown in FIG. 8. In this case, the driving device for the image to be displayed 800 may include: a voltage acquisition module 810, a load determination module 820, and a grayscale determination module 830.

The voltage acquisition module 810 is used for obtaining driving voltages for a plurality of sub-pixels corresponding to the image to be displayed.

The load determination module 820 is used for determining a driving load of each of source driver chips when driving each row of the plurality of sub-pixels according to the driving voltages for the plurality of sub-pixels.

The grayscale determination module 830 is used for determining a driving grayscale value for each one in an i-th row of the plurality of sub-pixels driven by an s-th one of the source driver chips according to the driving load of the s-th one of the source driver chips when driving the i-th row of the plurality of sub-pixels, s and i being positive integers.

Optionally, the load determination module 820 is further used for:
determining an initial load of each of the source driver chips when driving each row of the plurality of sub-pixels according to the driving voltages for the plurality of sub-pixels;
determining a total load for the i-th row of the plurality of sub-pixels according to the initial loads of the source driver chips when driving the i-th row of the plurality of sub-pixels; and
determining the driving load of the s-th one of the source driver chips when driving the i-th row of the plurality of sub-pixels, according to the initial load of the s-th one of the source driver chips when driving the i-th row of the plurality of sub-pixels and the total load for the i-th row of the plurality of sub-pixels.

Optionally, the load determination module 820 is further used for:
determining a pixel load for each one in the i-th row of the plurality of sub-pixels driven by the s-th one of the source driver chips according to the driving voltages for the plurality of sub-pixels;
determining the initial load of the s-th one of the source driver chips when driving the i-th row of the plurality of sub-pixels, according to the pixel loads for multiple ones in the i-th row of the plurality of sub-pixels driven by the s-th one of the source driver chips.

Optionally, the load determination module 820 is further used for:
for a Sᵢₜ-th sub-pixel in the i-th row driven by the s-th one of the source driver chips, determining a preceding sub-pixel being driven by the s-th one of the source driver chips before driving the Sᵢₜ-th sub-pixel, Sᵢₜ being a positive integer; and
determining the pixel load for the sᵢₜ-th sub-pixel according to one of the driving voltages for the Sᵢₜ-th sub-pixel and one of the driving voltages for the preceding sub-pixel.

Optionally, the load determination module 820 is further used for:
obtaining a first weight coefficient for each of the source driver chips, the first weight coefficient being used to indicate an influence degree of a load of the source driver chip on a supply voltage for a display device; and
performing a weighted summation on the initial loads of the source driver chips when driving the i-th row of the plurality of sub-pixels according to the first weight coefficients for the source driver chips, so as to obtain the total load for the i-th row of the plurality of sub-pixels.

Optionally, the load determination module 820 is further used for:
obtaining a second weight coefficient for each of the source driver chips, the second weight coefficient being used to indicate an influence degree of a decrease in a supply voltage for a display device on a load of the source driver chip; and
adding the initial load of the s-th one of the source driver chips when driving the i-th row of the plurality of sub-pixels to a product of the second weight coefficient for the s-th one of the source driver chips and the total load for the i-th row of the plurality of sub-pixels, so as to obtain the driving load of the s-th one of the source driver chips when driving the i-th row of the plurality of sub-pixels.

Optionally, the load determination module 820 is further used for:
correcting the driving load of the s-th one of the source driver chips when driving the i-th row of the plurality of sub-pixels according to the driving load of the s-th one of the source driver chips when driving an (i−1)-th row of the plurality of sub-pixels.

The corrected driving load of the s-th one of the source driver chips when driving the i-th row of the plurality of sub-pixels is used to determine the driving grayscale value for each one in the i-th row of the plurality of sub-pixels driven by the s-th one of the source driver chips.

Optionally, the load determination module 820 is further used for:
performing a weighted summation on the driving load of the s-th one of the source driver chips when driving the (i−1)-th row of the plurality of sub-pixels and the driving load of the s-th one of the source driver chips when driving the i-th row of the plurality of sub-pixels, so as to obtain the corrected driving load of the s-th one of the source driver chips when driving the i-th row of the plurality of sub-pixels.

Optionally, the grayscale determination module 830 is further used for:
for a sᵢₜ-th sub-pixel in the i-th row driven by the s-th one of the source driver chips, determining a grayscale mapping coefficient corresponding to the sᵢₜ-th sub-pixel according to a preset coefficient mapping table, an initial grayscale value for the Sᵢₜ-th sub-pixel, and the driving load of the s-th one of the source driver chips when driving the i-th row of the plurality of sub-pixels, the preset coefficient mapping table including the grayscale mapping coefficients corresponding to multiple sets of initial grayscale values and driving loads; and
determining a driving grayscale value for the sᵢₜ-th sub-pixel according to the grayscale mapping coefficient corresponding to the Sᵢₜ-th sub-pixel and the driving load of the s-th one of the source driver chips when driving the i-th row of the plurality of sub-pixels.

Optionally, the grayscale determination module 830 is further used for:
determining a compensation grayscale value for the Sᵢₜ-th sub-pixel according to the grayscale mapping coefficient corresponding to the Sᵢₜ-th sub-pixel and the driving load of the s-th one of the source driver chips when driving the i-th row of the plurality of sub-pixels; and
summing the initial grayscale value and the compensation grayscale value for the Sᵢₜ-th sub-pixel to obtain the driving grayscale value for the sᵢₜ-th sub-pixel.

Optionally, the grayscale determination module 830 is further used for:
optimizing the compensation grayscale value for the Sᵢₜ-th sub-pixel by using a voltage difference coefficient, the voltage difference coefficient being determined according to a voltage difference between a power supply voltage for a display device and a driving voltage for a target grayscale value.

Optionally, the grayscale determination module 830 is further used for:
for a Sᵢₜ-th sub-pixel in the i-th row driven by the s-th one of the source driver chips, determining the driving grayscale value for the Sᵢₜ-th sub-pixel according to a preset grayscale mapping table, an initial grayscale value for the Sᵢₜ-th sub-pixel, and the driving load of the s-th one of the source driver chips when driving the i-th row of the plurality of sub-pixels, the grayscale mapping table including the driving grayscale values corresponding to multiple sets of initial grayscale values and driving loads.

Optionally, the grayscale determination module 830 is further used for:
optimizing the driving grayscale value for the sᵢₜ-th sub-pixel by using a voltage difference coefficient, the voltage difference coefficient being determined according to a voltage difference between a power supply voltage for a display device and a driving voltage for a target grayscale value.

Optionally, the voltage acquisition module is further used for:
obtaining initial grayscale values for the plurality of sub-pixels corresponding to the image to be displayed;
determining a driving manner for the image to be displayed;
determining, if the driving manner is a positive polarity driving manner, the driving voltages for the plurality of sub-pixels according to the initial grayscale values for the plurality of sub-pixels and a preset first voltage mapping table, the preset first voltage mapping table including a mapping relationship between the initial grayscale values and the driving voltages in the positive polarity driving manner; and
determining, if the driving manner is a negative polarity driving manner, the driving voltages for the plurality of sub-pixels according to the initial grayscale values for the plurality of sub-pixels and a preset second voltage mapping table, the preset second voltage mapping table including a mapping relationship between the initial grayscale values and the driving voltages in the negative polarity driving manner.

In summary, for the driving method for the image to be displayed provided in the embodiments of the present application of the application, the driving loads of the source driver chips when driving the sub-pixels in each row are determined according to the driving voltages for the plurality of sub-pixels corresponding to the image to be displayed, the driving grayscale values for the sub-pixels in each row driven by each source driver chip are determined according to the driving loads, and the sub-pixels are driven according to the driving grayscale values to achieve image display. Since the driving loads are determined according to the driving voltages for the sub-pixels, the driving loads can reflect the fluctuation of the driving voltages, thus enabling real-time quantification of the degree of dark lines caused by insufficient driving. Moreover, the driving grayscale value for each sub-pixel is calculated according to the driving loads, which can achieve targeted grayscale compensation for each sub-pixel, to eliminate horizontal crosstalk caused by insufficient driving in real-time, avoid the appearance of single or multiple abnormal dark lines in the image to be displayed, and enhance the display performance of the display device.

It should be understood that, in specific implementations, the above modules may be implemented as independent entities, or combined in any manner as one or several entities.

People skilled in the art can understand that the above program code or IP core may be stored in a computer-readable storage medium, loaded and executed by a processor.

In light of this, embodiments of the present application provide a computer-readable storage medium, which stores program code or an IP core, which can be loaded by a processor to perform any step of the driving method for the image to be displayed provided in the embodiments of the present application. For example, the program code or IP core can execute the following steps:
obtaining the driving voltages for the plurality of sub-pixels corresponding to the image to be displayed;
determining the driving loads of the source driver chips when driving the sub-pixels in each row according to the driving voltages for the plurality of sub-pixels; and
determining the driving grayscale values for the sub-pixels in the i-th row driven by the s-th source driver chip according to the driving load of the s-th source driver chip when driving the sub-pixels in the i-th row, where s is a positive integer, and i is a positive integer.

The computer-readable storage medium may include: read-only memory (ROM), random access memory (RAM), disk, or optical disk, etc.

Since the program code or IP core stored in the computer-readable storage medium can perform any step of the driving method for the image to be displayed provided in the embodiments of the present application, the beneficial effects that can be achieved by the driving method for the image to be displayed provided in the embodiments of the present application can be realized, as detailed in the above embodiments, and will not be repeated here.

Embodiments of the present application provide a display device including a display panel and the driving device for the image to be displayed described in the above embodiments.

Specific implementation of the above operations and the corresponding beneficial effects can be referred to the detailed description of the driving method for the image to be displayed in the above embodiments, and will not be repeated here.

The driving method for the image to be displayed, the driving device for the image to be displayed, and the display device are described in details in the present application. Specific examples have been described in this content to illustrate the principles and implementation methods of the present application. The descriptions of the embodiments are only intended to assist in understanding the methods and core concepts of the present application. In addition, for those skilled in the art, modifications will be made in the specific implementation methods and the scope of application based on the ideas of this application. In summary, the content of this specification should not be construed as a limitation on the scope of the present application.

1. A driving method for an image to be displayed, wherein the driving method comprises:
obtaining driving voltages for a plurality of sub-pixels corresponding to the image to be displayed;
determining a driving load of each of source driver chips when driving each row of the plurality of sub-pixels according to the driving voltages for the plurality of sub-pixels; and
determining a driving grayscale value for each one in an i-th row of the plurality of sub-pixels driven by an s-th one of the source driver chips according to the driving load of the s-th one of the source driver chips when driving the i-th row of the plurality of sub-pixels, wherein s and i are positive integers.

2. The driving method for the image to be displayed according to claim 1, wherein the determining the driving load of each of the source driver chips when driving each row of the plurality of sub-pixels according to the driving voltages for the plurality of sub-pixels, comprises:
determining an initial load of each of the source driver chips when driving each row of the plurality of sub-pixels according to the driving voltages for the plurality of sub-pixels;
determining a total load for the i-th row of the plurality of sub-pixels according to the initial loads of the source driver chips when driving the i-th row of the plurality of sub-pixels; and
determining the driving load of the s-th one of the source driver chips when driving the i-th row of the plurality of sub-pixels, according to the initial load of the s-th one of the source driver chips when driving the i-th row of the plurality of sub-pixels and the total load for the i-th row of the plurality of sub-pixels.

3. The driving method for the image to be displayed according to claim 2, wherein the determining the initial load of each of the source driver chips when driving each row of the plurality of sub-pixels according to the driving voltages for the plurality of sub-pixels, comprises:
determining a pixel load for each one in the i-th row of the plurality of sub-pixels driven by the s-th one of the source driver chips according to the driving voltages for the plurality of sub-pixels; and
determining the initial load of the s-th one of the source driver chips when driving the i-th row of the plurality of sub-pixels, according to the pixel loads for multiple ones in the i-th row of the plurality of sub-pixels driven by the s-th one of the source driver chips.

4. The driving method for the image to be displayed according to claim 3, wherein the determining the pixel load for each one in the i-th row of the plurality of sub-pixels driven by the s-th one of the source driver chips according to the driving voltages for the plurality of sub-pixels, comprises:
for a sᵢₜ-th sub-pixel in the i-th row driven by the s-th one of the source driver chips, determining a preceding sub-pixel being driven by the s-th one of the source driver chips before driving the sᵢₜ-th sub-pixel, wherein sᵢₜ is a positive integer; and
determining the pixel load for the sᵢₜ-th sub-pixel according to one of the driving voltages for the sᵢₜ-th sub-pixel and one of the driving voltages for the preceding sub-pixel.

5. The driving method for the image to be displayed according to claim 2,
wherein the determining the total load for the i-th row of the plurality of sub-pixels according to the initial loads of the source driver chips when driving the i-th row of the plurality of sub-pixels, comprises:
obtaining a first weight coefficient for each of the source driver chips, the first weight coefficient being used to indicate an influence degree of a load of the source driver chip on a supply voltage for a display device; and
performing a weighted summation on the initial loads of the source driver chips when driving the i-th row of the plurality of sub-pixels according to the first weight coefficients for the source driver chips, so as to obtain the total load for the i-th row of the plurality of sub-pixels.

6. The driving method for the image to be displayed according to claim 2, wherein the determining the driving load of the s-th one of the source driver chips when driving the i-th row of the plurality of sub-pixels, according to the initial load of the s-th one of the source driver chips when driving the i-th row of the plurality of sub-pixels and the total load for the i-th row of the plurality of sub-pixels, comprises:
obtaining a second weight coefficient for each of the source driver chips, the second weight coefficient being used to indicate an influence degree of a decrease in a supply voltage for a display device on a load of the source driver chip; and
adding the initial load of the s-th one of the source driver chips when driving the i-th row of the plurality of sub-pixels to a product of the second weight coefficient for the s-th one of the source driver chips and the total load for the i-th row of the plurality of sub-pixels, so as to obtain the driving load of the s-th one of the source driver chips when driving the i-th row of the plurality of sub-pixels.

7. The driving method for the image to be displayed according to claim 1, wherein after the determining the driving load of each of the source driver chips when driving each row of the plurality of sub-pixels according to the driving voltages for the plurality of sub-pixels, the driving method further comprises:
correcting the driving load of the s-th one of the source driver chips when driving the i-th row of the plurality of sub-pixels according to the driving load of the s-th one of the source driver chips when driving an (i-1)-th row of the plurality of sub-pixels;
wherein the corrected driving load of the s-th one of the source driver chips when driving the i-th row of the plurality of sub-pixels is used to determine the driving grayscale value for each one in the i-th row of the plurality of sub-pixels driven by the s-th one of the source driver chips.

8. The driving method for the image to be displayed according to claim 7, wherein the correcting the driving load of the s-th one of the source driver chips when driving the i-th row of the plurality of sub-pixels according to the driving load of the s-th one of the source driver chips when driving the (i-1)-th row of the plurality of sub-pixels, comprises:
performing a weighted summation on the driving load of the s-th one of the source driver chips when driving the (i-1)-th row of the plurality of sub-pixels and the driving load of the s-th one of the source driver chips when driving the i-th row of the plurality of sub-pixels, so as to obtain the corrected driving load of the s-th one of the source driver chips when driving the i-th row of the plurality of sub-pixels.

9. The driving method for the image to be displayed according to claim 1, wherein the determining the driving grayscale value for each one in the i-th row of the plurality of sub-pixels driven by the s-th one of the source driver chips according to the driving load of the s-th one of the source driver chips when driving the i-th row of the plurality of sub-pixels, comprises:
for a sᵢₜ-th sub-pixel in the i-th row driven by the s-th one of the source driver chips, determining a grayscale mapping coefficient corresponding to the sᵢₜ-th sub-pixel according to a preset coefficient mapping table, an initial grayscale value for the sᵢₜ-th sub-pixel, and the driving load of the s-th one of the source driver chips when driving the i-th row of the plurality of sub-pixels, wherein the preset coefficient mapping table comprises the grayscale mapping coefficients corresponding to multiple sets of initial grayscale values and driving loads; and
determining a driving grayscale value for the sᵢₜ-th sub-pixel according to the grayscale mapping coefficient corresponding to the sᵢₜ-th sub-pixel and the driving load of the s-th one of the source driver chips when driving the i-th row of the plurality of sub-pixels.

10. The driving method for the image to be displayed according to claim 9, wherein the determining the driving grayscale value for the sᵢₜ-th sub-pixel according to the grayscale mapping coefficient corresponding to the sᵢₜ-th sub-pixel and the driving load of the s-th one of the source driver chips when driving the i-th row of the plurality of sub-pixels, comprises:
determining a compensation grayscale value for the sᵢₜ-th sub-pixel according to the grayscale mapping coefficient corresponding to the sᵢₜ-th sub-pixel and the driving load of the s-th one of the source driver chips when driving the i-th row of the plurality of sub-pixels; and
summing the initial grayscale value and the compensation grayscale value for the sᵢₜ-th sub-pixel to obtain the driving grayscale value for the sᵢₜ-th sub-pixel.

11. The driving method for the image to be displayed according to claim 10, wherein before the summing the initial grayscale value and the compensation grayscale value for the Sᵢₜ-th sub-pixel to obtain the driving grayscale value for the sᵢₜ-th sub-pixel, the driving method further comprises:
optimizing the compensation grayscale value for the sᵢₜ-th sub-pixel by using a voltage difference coefficient, wherein the voltage difference coefficient is determined according to a voltage difference between a power supply voltage for a display device and a driving voltage for a target grayscale value.

12. The driving method for the image to be displayed according to claim 1, wherein the determining the driving grayscale value for each one in the i-th row of the plurality of sub-pixels driven by the s-th one of the source driver chips according to the driving load of the s-th one of the source driver chips when driving the i-th row of the plurality of sub-pixels, comprises:
for a sᵢₜ-th sub-pixel in the i-th row driven by the s-th one of the source driver chips, determining the driving grayscale value for the sᵢₜ-th sub-pixel according to a preset grayscale mapping table, an initial grayscale value for the sᵢₜ-th sub-pixel, and the driving load of the s-th one of the source driver chips when driving the i-th row of the plurality of sub-pixels, wherein the grayscale mapping table comprises the driving grayscale values corresponding to multiple sets of initial grayscale values and driving loads.

13. The driving method for the image to be displayed according to claim 12, wherein after the determining the driving grayscale value for the sᵢₜ-th sub-pixel according to the preset grayscale mapping table, the initial grayscale value for the sᵢₜ-th sub-pixel, and the driving load of the s-th one of the source driver chips when driving the i-th row of the plurality of sub-pixels, the driving method further comprises:
optimizing the driving grayscale value for the sᵢₜ-th sub-pixel by using a voltage difference coefficient, wherein the voltage difference coefficient is determined according to a voltage difference between a power supply voltage for a display device and a driving voltage for a target grayscale value.

14. The driving method for the image to be displayed according to claim 1, wherein the obtaining the driving voltage for the plurality of sub-pixels corresponding to the image to be displayed, comprises:
obtaining initial grayscale values for the plurality of sub-pixels corresponding to the image to be displayed;
determining a driving manner for the image to be displayed;
if the driving manner is a positive polarity driving manner, determining the driving voltages for the plurality of sub-pixels according to the initial grayscale values for the plurality of sub-pixels and a preset first voltage mapping table, the preset first voltage mapping table comprising a mapping relationship between the initial grayscale values and the driving voltages in the positive polarity driving manner; and
if the driving manner is a negative polarity driving manner, determining the driving voltages for the plurality of sub-pixels according to the initial grayscale values for the plurality of sub-pixels and a preset second voltage mapping table, the preset second voltage mapping table comprising a mapping relationship between the initial grayscale values and the driving voltages in the negative polarity driving manner.

15. A driving device for an image to be displayed, wherein the driving device comprises:
a voltage acquisition module used for obtaining driving voltages for a plurality of sub-pixels corresponding to the image to be displayed;
a load determination module used for determining a driving load of each of source driver chips when driving each row of the plurality of sub-pixels according to the driving voltages for the plurality of sub-pixels; and
a grayscale determination module used for determining a driving grayscale value for each one in an i-th row of the plurality of sub-pixels driven by an s-th one of the source driver chips according to the driving load of the s-th one of the source driver chips when driving the i-th row of the plurality of sub-pixels, wherein s and i are positive integers.

16. The driving device for the image to be displayed according to claim 15, wherein the load determination module is further used for:
determining an initial load of each of the source driver chips when driving each row of the plurality of sub-pixels according to the driving voltages for the plurality of sub-pixels;
determining a total load for the i-th row of the plurality of sub-pixels according to the initial loads of the source driver chips when driving the i-th row of the plurality of sub-pixels; and
determining the driving load of the s-th one of the source driver chips when driving the i-th row of the plurality of sub-pixels, according to the initial load of the s-th one of the source driver chips when driving the i-th row of the plurality of sub-pixels and the total load for the i-th row of the plurality of sub-pixels.

17. The driving device for the image to be displayed according to claim 16, wherein the load determination module is further used for:
determining a pixel load for each one in the i-th row of the plurality of sub-pixels driven by the s-th one of the source driver chips according to the driving voltages for the plurality of sub-pixels; and
determining the initial load of the s-th one of the source driver chips when driving the i-th row of the plurality of sub-pixels, according to the pixel loads for multiple ones in the i-th row of the plurality of sub-pixels driven by the s-th one of the source driver chips.

18. The driving device for the image to be displayed according to claim 17, wherein the load determination module is further used for:
for a sᵢₜ-th sub-pixel in the i-th row driven by the s-th one of the source driver chips, determining a preceding sub-pixel being driven by the s-th one of the source driver chips before driving the sᵢₜ-th sub-pixel, wherein sᵢₜ is a positive integer; and
determining the pixel load for the sᵢₜ-th sub-pixel according to one of the driving voltages for the sᵢₜ-th sub-pixel and one of the driving voltages for the preceding sub-pixel.

19. The driving device for the image to be displayed according to claim 16, wherein the load determination module is further used for:
obtaining a first weight coefficient for each of the source driver chips, the first weight coefficient being used to indicate an influence degree of a load of the source driver chip on a supply voltage for a display device; and
performing a weighted summation on the initial loads of the source driver chips when driving the i-th row of the plurality of sub-pixels according to the first weight coefficients for the source driver chips, so as to obtain the total load for the i-th row of the plurality of sub-pixels.

20. A display device, wherein the display device comprises: a display panel, and a driving device for an image to be displayed, wherein the driving device comprises:
a voltage acquisition module used for obtaining driving voltages for a plurality of sub-pixels corresponding to the image to be displayed;
a load determination module used for determining a driving load of each of source driver chips when driving each row of the plurality of sub-pixels according to the driving voltages for the plurality of sub-pixels; and
a grayscale determination module used for determining a driving grayscale value for each one in an i-th row of the plurality of sub-pixels driven by an s-th one of the source driver chips according to the driving load of the s-th one of the source driver chips when driving the i-th row of the plurality of sub-pixels, wherein s and i are positive integers.
